(19) United States
(12) Patent Application Publication
(10) Pub. No.: US 2005/0243104 A1
(43) Pub. Date: Nov. 3, 2005

(54) Method of labelling an image on a display

(76) Inventor: John R. Kinghorn, Surrey (GB)

Correspondence Address: PHILIPS INTELLECTUAL PROPERTY & STANDARDS, P.O. BOX 3001, BRIARCLIFF MANOR, NY, 10510, US

(21) Appl. No.: 10/511,210

(22) PCT Filed: Apr. 3, 2003
(86) PCT No.: PCT/IB03/01357

§ 371 Date: Oct. 13, 2004

(30) Foreign Application Priority Data
Apr. 18, 2002 (GB) 0208835.9

(51) Int. Cl. G09G 5/00

(52) U.S. Cl. 345/649; 345/632

(57) ABSTRACT

A method of labelling an image for display on a screen is disclosed together with a computer program, a computer-readable storage medium and apparatus for the same. The method comprises the steps of retrieving the image, displaying the image rotated, and displaying first and second text labels on the image wherein each label identifies a part or feature of the image, and wherein the first text label is displayed in accordance with one labelling scheme, and the second text label is displayed in accordance with a different labelling scheme. Also disclosed is a method of labelling in which a text label is displayed on a rotated image wherein the label is rotated to one of a plurality of possible orientations relative to the rotated image.

This invention relates to a method of labelling an image for display on a screen and to a computer program, a computer-readable storage medium and apparatus for the same. In particular, the invention relates to a method in which a rotatable image such as a map is displayed and text labels associated with parts or features of that image are displayed dynamically.

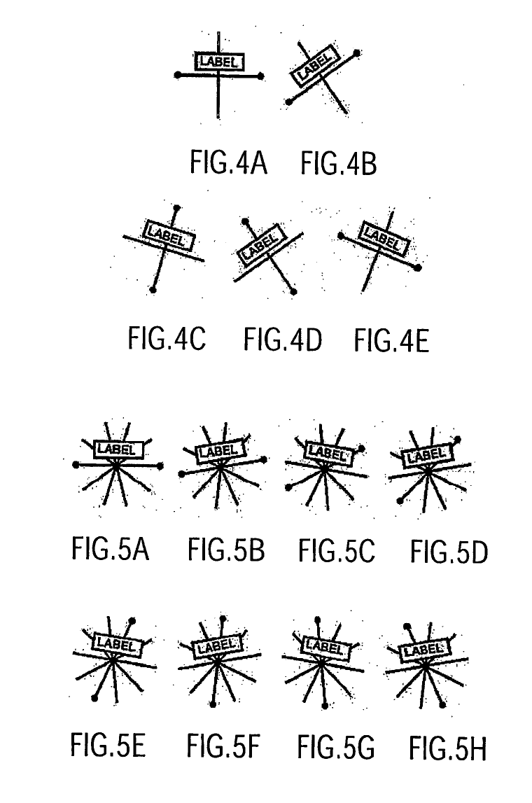

PCT patent application, publication number WO86/02764 discloses displaying a street map with dynamic labelling of the streets wherein “each label is placed close to and parallel to its corresponding street and with an orientation closest to right side up” and wherein, as illustrated in FIGS. 4A to 4G of WO86/02764, the orientation of the text of each label is flipped 180° when the label passes vertical.

U.S. Pat. No. 6,011,494 discloses displaying a map in “bird's eye view” mode wherein the orientation of the map changes depending on the direction of travel of a vehicle or a user, and wherein, as illustrated in FIG. 27 of U.S. Pat. No. 6,011,494, the orientation of labels of features of the map is uniformly horizontal.

U.S. Pat. No. 5,297,051 discloses displaying a street map with dynamic labelling of the streets wherein individual characters of each label remain upright when a label is changed from horizontal to vertical orientation upon the direction of display of the map being changed between North or South and East or West.

It is an object of the invention to provide an improved method of labelling parts or features of a rotatable image for display on a screen and, in particular, where the image and/or labelling are especially complicated.

In accordance with a first aspect of the present invention, a method of labelling an image for display on a screen is provided comprising the steps of retrieving the image, displaying the image rotated, and displaying first and second text labels on the image wherein each label identifies a part or feature of the image, and wherein the first text label is displayed in accordance with a first labelling scheme, and the second text label is displayed in accordance with a second labelling scheme, different from the first labelling scheme

Whilst the prior art teaches displaying one or other of superimposed text labels which rotate with an image or superimposed text labels which have a fixed orientation over an image, the inventor has realised that it is desirable to have a combination of these, especially when the image and/or associated labelling are especially complicated. The inventor has appreciated that certain parts or features of an image such as a map are most clearly labelled using a particular labelling technique, and therefore a combination of such labelling techniques ensures that when an image having different parts or features labelled rotates, the labelling remains clear and easy to read.

The method may further comprise the step of displaying the image unrotated prior to displaying the image rotated wherein the first and second text labels are displayed on the unrotated image in accordance with the same respective schemes as used for the rotated image.

Also, each text label displayed on the image may be retrieved for display from a database which indicates either directly or indirectly which labelling scheme it is to be displayed in accordance with.

If the first and second text labels are members of first and second groups of text labels respectively, text labels in the same group are ideally displayed in accordance with the same labelling scheme.

One of the labelling schemes may consists of displaying text labels rotated with the image, of displaying text labels horizontal on the display (i.e. without rotation) or, in accordance with a second aspect of the present invention, displaying text labels rotated to one of a plurality of possible orientations relative to the rotated image. In the case of the latter, the angular separation between those possible orientations may be constant and, ideally, the number of such possible orientations odd.

The present invention will now be described, by way of example only, with reference to the accompanying figures in which:

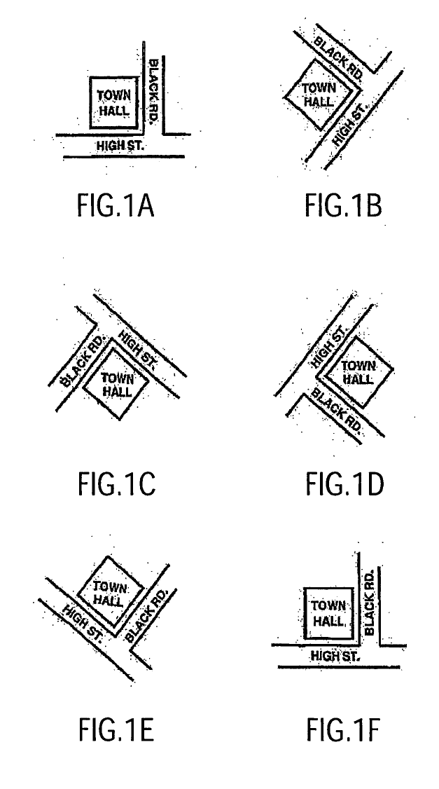

FIGS. 1A to 1F are images labelled with text labels using a labelling method according to a first aspect of the present invention;

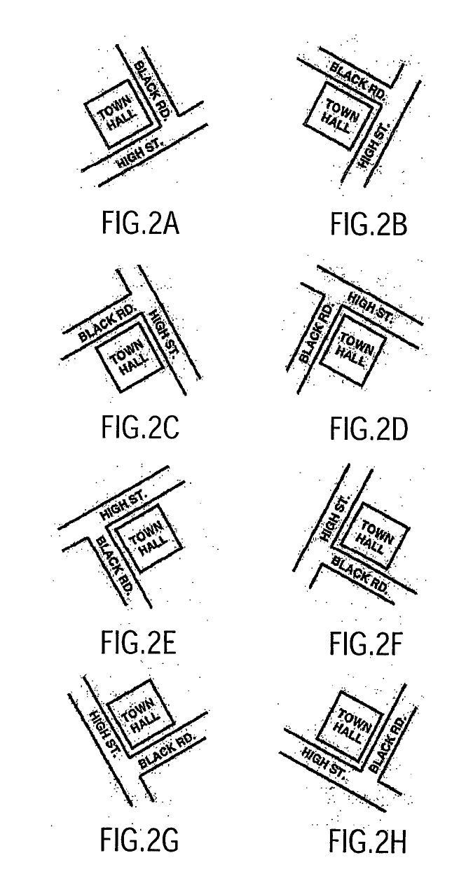

FIGS. 2A to 2H are images labelled with text labels using an alternative labelling method according to a second aspect of the present invention;

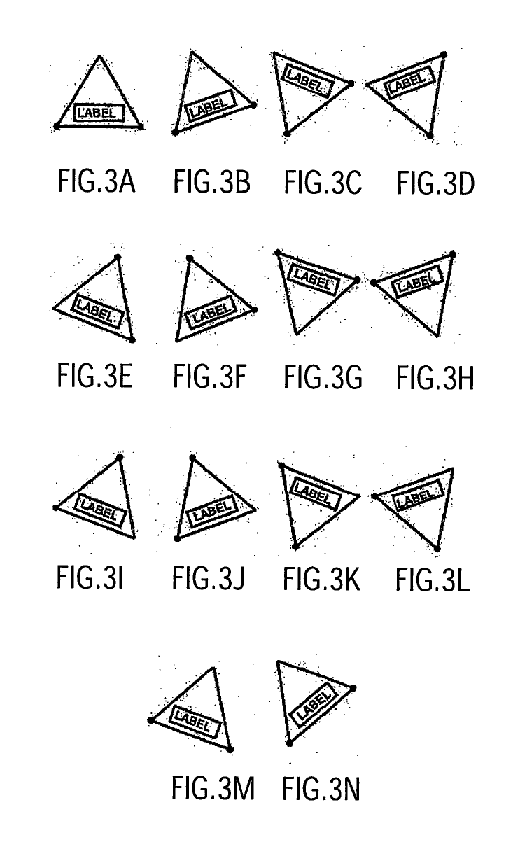

FIGS. 3A to 3N, 4A to 4E and 5A to 5K are diagrams further illustrating the alternative labelling method illustrated in FIGS. 2A to 2H; and

FIG. 6 shows, schematically, a computer system capable of implementing a labelling method in accordance with the present invention.

FIGS. 1A to 1F are images composed of an extract from a map together with associated text labels for display on a conventional display. Specifically, the image consists of connecting roads High Street and Black Road with a feature, in this case a “Town Hall”, located at their junction. FIGS. 1A to 1E shown the same map in five different orientations whereby from an initial orientation in FIG. 1A, the map of FIGS. 1B, 1C, 1D and 1E are rotated anti-clockwise by approximately 45°, 135°, 225° and 315° respectively.

The labels of Black Road and the High Street are superimposed on the image such that they rotate with the map and such that the text of those labels are oriented as summarised in table 1 below in order to ensure that the text remains upright.

TABLE 1
Orientation of the text of the road labels in FIGS. 1A to 1E

| Road | | | | | |
|---|---|---|---|---|---|
| High Street | Normal | Normal | Flipped | Flipped | Normal |
| Black Road | Normal | Normal | Normal | Flipped | Flipped |

When a text label is rotated past vertical, the orientation of the text is flipped 180° to ensure it remains upright. This may at precisely vertical, as the label approaches vertical or just after vertical. Also, the default orientation of the text at vertical may be as illustrated by Black Road in FIG. 1A or, alternatively, as illustrated by the same in FIG. 1F.

The orientation of the label of the Town Hall remains constantly horizontal, notwithstanding the rotation of the map.

FIGS. 2A to 2H are the same images as shown in FIGS. 1A to 1F with an alternative method of labelling. From an initial orientation in FIG. 2A, the maps of FIGS. 2B, 2C, 2D, 2E, 2F, 2G and 2H are rotated anti-clockwise by 30°, 60°, 120°, 150°, 210°, 240°, 300° and 330° respectively.

The labels of Black Road and the High Street are superimposed on the image in the same way as described with reference to FIGS. 1A to 1E above. The rotation of the labels of the “Town Hall” feature, summarised in table 2 below, follows that of the image except that the text label may be further rotated 90°, 180° or 270° clockwise such that the label remains parallel to the sides of the square “Town Hall” feature which are closest to horizontal and such that the text of those labels remains upright.

TABLE 2
Rotation of the “Town Hall” label in FIGS. 3A to 3I

| | FIG. | | | | | | | | |
|---|---|---|---|---|---|---|---|---|---|
| | 2A | 2B | 2C | 2D | 2E | 2F | 2G | 2H | 2I |
| Image | 0 | 30 | 60 | 120 | 150 | 210 | 240 | 300 | 330 |
| Rotation (°) | | | | | | | | | |
| Label | 0 | 30 | −30 | 30 | −30 | 30 | −30 | 30 | −30 |
| Rotation (°) | | | | | | | | | |

The underlying principle of the labelling of the square “Town Hall” feature of FIGS. 2A to 2H can be extended to labelling of different shapes as shown in FIGS. 3A to 3M which from an initial orientation in FIG. 3A, a triangle feature is rotated anti-clockwise by 20°, 40°, 80°, 100°, 140°, 160°, 200°, 220°, 260°, 280°, 320° and 340° respectively.

The rotation of the labels of the triangle feature, summarised in table 3 below, follows that of the image except that the text label may be further rotated 60°, 120°, 180°, 240° or 300° clockwise such that the label remains parallel to the side of the triangle which is closest to horizontal and such that the text of those labels remains upright. As the text labels have 3 possible orientations with an constant angular separation between them, the maximum deviation from the horizontal is ±30°.

TABLE 3
Rotation of the “Town Hall” label in FIGS. 3A to 3M

| | FIG. | | | | | | | | | | | | |
|---|---|---|---|---|---|---|---|---|---|---|---|---|---|
| | 3A | 3B | 3C | 3D | 3E | 3F | 3G | 3H | 3I | 3J | 3K | 3L | 3M |
| Image | 0 | 20 | 40 | 80 | 100 | 140 | 160 | 200 | 220 | 260 | 280 | 320 | 340 |
| Rotation (°) | | | | | | | | | | | | | |
| Label | 0 | 20 | −20 | 20 | −20 | 20 | −20 | 20 | −20 | 20 | −20 | 20 | −20 |
| Rotation (°) | | | | | | | | | | | | | |

If it is desired to label a shape with the label parallel to one or other of the lower or upper sides of the triangle, the maximum deviation from the horizontal is increased to ±60°. This is illustrated in FIG. 3N where instead of the labelling shown in 3C, the alternative labelling shown in FIG. 3N is applied such that the label continues to be parallel to one or other of the lower sides of the triangle as is the case in FIGS. 3A and 3B.

The labelling method used to label the square “Town Hall” feature in FIGS. 2A to 2H and the triangular feature in FIGS. 3A to 3M is not limit to labelling polygons but rather can be used at any time when a label can be displayed rotated at any number of possible orientations relative to a rotated image.

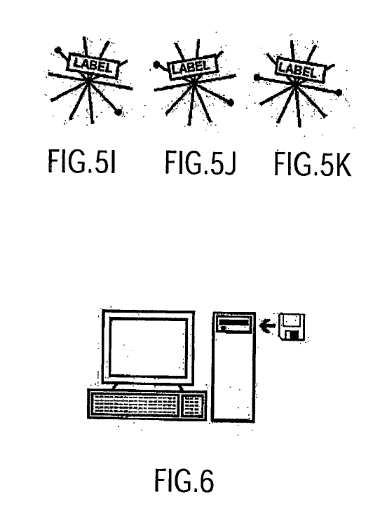

For example, see FIGS. 4A to 4E and FIGS. 5A to 5K in which, for four and five possible orientations respectively, a reference line (indicated by dots at either end of the line) is rotated anti-clockwise 180° and labelled such that the label has one of four or five possible orientations relative to the rotated reference line, and such that the label is oriented to be as close as possible to the horizontal.

It is noteworthy that because of symmetry where there is a even number of possible orientations with a constant angular separation between them, the maximum deviation of the orientations of the labels from the horizontal is greater than would be the case if that number were reduced, by up to a half, to an odd number of possible orientations. When there are three, four and five possible, equally spaced orientation, the maximum deviation of the orientations of the labels from the horizontal is ±30°, ±45° and ±18° respectively.

Dynamic labelling whereby an map image and the associated labels are stored independently and the map selective labelled depending on a user's requirement is known from at least U.S. Pat. No. 6,011,494. To facilitate such selective labelling and to utilise the present invention, it is desirable for each text label to be retrieved for display from a database which identifies which manner of labelling is to be used. That is, whether the label is to be displayed rotated with the image or not. Where first and second groups of text labels are displayed, it may be convenient for each text label to be retrieved for display from a database which identifies which group that text label belongs to, thereby indicating whether it is to be displayed rotated with the image or not.

A conventional computer system capable of implementing the above method is shown schematically in FIG. 4 comprising a display, a CPU tower with a floppy disc drive and a keyboard, all coupled to the processor in known manner. Implementation of a method according to the present invention in such a computer system may be readily accomplished in hardware, in a computer program (either in situ on a computer or stored on storage media) by appropriate computer programming and configuration or through a combination of both. Of course, such programming and configuration is well known and would be accomplished by one of ordinary skill in the art without undue burden.

It would be further understood by one of ordinary skill in the art that the teaching of the present invention applies equally to other types of apparatus having a display and not only to the aforementioned computer system. For example, the invention may be employed on a mobile terminal such as a PDA or vehicle navigation system which displays a rotated map depending on the orientation of the device, and/or the heading of the user or host vehicle.

1. A method of labelling an image for display on a screen comprising the steps of retrieving the image, displaying the image rotated, and displaying first and second text labels on the image wherein each label identifies a part or feature of the image, and wherein the first text label is displayed in accordance with one labelling scheme, and the second text label is displayed in accordance with a different labelling scheme.

2. A method according to claim 1 wherein one of the labelling schemes consists of displaying text labels rotated with the image.

3. A method according to claim 1 wherein one of the labelling schemes consists of displaying text labels rotated to one of a plurality of possible orientations relative to the rotated image.

4. A method according to claim 3 wherein one of the labelling schemes consists of displaying text labels rotated to one of a plurality of possible orientations relative to the rotated image; and wherein the angular separation between those possible orientations is constant.

5. A method according to claim 4 wherein one of the labelling schemes consists of displaying text labels rotated to one of an odd plurality of possible orientations relative to the rotated image.

6. A method according to claim 1 wherein one of the labelling schemes consists of displaying text labels horizontal on the display.

7. A method according to any preceding claim further comprising the step of displaying the image unrotated prior to displaying the image rotated, wherein the first and second text labels are displayed on the unrotated image in accordance with the same respective schemes as used for the rotated image.

8. A method according to any preceding claim wherein each text label displayed on the image is retrieved for display from a database which indicates either directly or indirectly which labelling scheme it is to be displayed in accordance with.

9. A method according to any preceding claim wherein the first and second text labels are members of first and second groups of text labels respectively; and wherein text labels in the same group are displayed in accordance with the same labelling scheme.

10. A method of labelling an image for display on a screen comprising the steps of retrieving the image, displaying the image rotated, and displaying a text label on the image rotated to one of a plurality of possible orientations relative to the rotated image.

11. A method according to claim 10 wherein the angular separation between those possible orientations is constant.

12. A method according to claim 11 wherein the angular separation between those possible orientations is constant and the number of possible orientations relative to the rotated image is odd.

13. A computer program comprising instructions for performing a method according to any preceding claim.

14. A computer-readable storage medium having recorded thereon data representing instructions for performing a method according to any of claims 1 to 12.

15. Apparatus having a display and a processor configured to perform a method according to any of claims 1 to 1.
